(19) United States
(12) Patent Application Publication
(10) Pub. No.: US 2022/0143894 A1
(43) Pub. Date: May 12, 2022

(54) METHOD FOR PRODUCING A BATTERY

(71) Applicant: VOLKSWAGEN AG, Wolfsburg (DE)

(72) Inventor: Henning DREGER, Braunschweig (DE)

(73) Assignee: VOLKSWAGEN AKTIENGESELLSCHAFT, Wolfsburg (DE)

(21) Appl. No.: 17/605,706

(22) PCT Filed: Feb. 12, 2020
(86) PCT No.: PCT/EP2020/053597

§ 371 Date: Dec. 30, 2021

(30) Foreign Application Priority Data
Apr. 24, 2019 (DE) 10 2019 205 825.6

(51) Int. Cl. B29C 48/92; B29C 48/00; H01M 4/04

(52) U.S. Cl. CPC B29C 48/92; B29C 48/402; H01M 4/0411; B29C 48/022

(57) ABSTRACT

In a method for producing batteries in which a suspension with a variable product parameter is extruded in an extrusion process by means of an extruder as an electrode paste, a number of extrusion parameters of the extrusion process are determined, an extruder-specific stress model is calculated on the basis of the extrusion parameters, and the extrusion process is controlled in an open loop and/or regulated, i.e., controlled in a closed loop, on the basis of the stress model.

The invention relates to a method for producing a battery in which a suspension is extruded as an electrode paste in an extrusion process by means of an extruder. The invention also relates to a device for carrying out the method and to a battery produced in accordance with the method.

Electrically powerable or powered motor vehicles such as, for example, electric or hybrid vehicles typically have a prime mover in the form of an electric motor which is coupled to an on-board (high-voltage) electrical energy storage device in order to be supplied with electrical energy. Such energy storage devices take the form of, for example, (vehicle) batteries.

In this context, an electrochemical battery is understood to be in particular what is commonly referred to as a secondary battery of the motor vehicle, where the chemical energy consumed is restored by an electrical (re-)charging process. Such batteries are in particular in the form of rechargeable electrochemical batteries, such as rechargeable lithium-ion batteries. To generate or provide a sufficiently high operating voltage, such batteries typically have a plurality of individual battery cells which are modularly interconnected.

Batteries of the type mentioned have a cathode and an anode as well as a separator and an electrolyte at the battery cell level. The electrodes; i.e., the anode and the cathode, are each made from a respective electrode active material. The electrode active material is a prerequisite for a high-power battery. Electrode active materials are often mixed with conductive particles as a conductive additive to improve the electrical properties. Due to their high conductivity, carbon-based conductive particles, such as carbon black or conductive graphite, are important constituents of lithium-ion batteries because they reduce the electrode resistance, and thus the internal resistance of the battery.

The production of electrically powerable or powered motor vehicles, in particular of the batteries needed for such vehicles, suffers the drawback of requiring large amounts of energy. Therefore, it is desirable to reduce to the maximum possible extent the energy and cost required to produce the batteries.

Batteries can be produced using extrusion methods in which the electrodes of the batteries cells are made from a plastically deformable material pressed out of a nozzle element. By integrating a continuous extrusion process into the fabrication of lithium-ion batteries, it is possible to significantly reduce the process time and energy required in the production of batteries because of the high efficiency of the mixing process. In the extrusion process, the electrodes of the battery or battery cells are produced using extruded electrode pastes, the paste quality being determined via specific criteria or product characteristics, for example via a particle size of the conductive particles. The electrode pastes are then applied, for example, to a respective current collector, in particular to a copper foil or an aluminum foil.

The closed-loop control and/or open-loop control of a continuously operated extruder; i.e., of its extrusion or operating parameters, for the production of electrode pastes for lithium-ion batteries has hitherto been performed manually and upon sampling and analysis of the electrode paste. In other words, machine parameters, such as rotational speed or mass or volumetric flow rate of the extruder, are controlled in closed loop and/or set only manually. This results in a low level of automation, which is associated with degraded response times and increased rejects and adversely affects process capability in the production of batteries.

It is an object of the invention to provide a particularly suitable method for producing a battery. In particular, it is desired to enable a most efficient and automated extrusion process. A further object of the invention is to provide a particularly suitable device for carrying out the method as well as a battery produced in accordance with such a method.

In accordance with the invention, these objects are achieved with respect to the method by the features of claim 1, with respect to the device by the feature of claim 9, and with respect to the battery by the features of claim 10. Advantageous embodiments and refinements are the subject matter of the dependent claims. The advantages and embodiments described for the method are analogously applicable to the extruder and the battery and vice versa.

The inventive method is suitable and adapted for producing batteries, in particular for producing lithium-ion batteries. In accordance with the method, a suspension with a variable product parameter is extruded (i.e., substantially continuously produced) as an electrode paste in an extrusion process by means of an extruder. In this context, an electrode paste is understood to be the extrudate; i.e., the extruded composite of the suspension. The suspension is essentially a solid composition of an electrode active material and a binder (binding agent), possibly with addition of conductive additives.

In a first step of the method, a number of extrusion parameters are determined as operating and machine parameters of the extrusion process and the extruder. In a subsequent step, an extruder-specific stress model is calculated on the basis of these extrusion parameters.

Subsequently, the extrusion process is controlled in open loop and/or closed loop on the basis of the stored stress model. As used here and hereinafter, the conjunction “and/or” is to be taken to mean that the features combined by this conjunction may be implemented together or as alternatives. This means that during operation, the extruder and its extrusion parameters are automatically and preferably continuously controlled in open loop and/or closed loop, in particular with respect to the product parameter, using the calculated stress model. In this way, a particularly suitable method for producing a battery is implemented.

The inventive method essentially implements real-time adjustment of the extrusion parameters; i.e., of the manufacturing parameters, whereby a reduction in the number of rejects is achieved. In particular, through automatic closed-loop control and/or open-loop control on the basis of the stress model, a constant product quality can be obtained even in the case of changed product parameters without requiring manual intervention by a user.

The extrusion parameters are acquired, for example, as analysis data, for example in the form of viscosity data or residence time data, and processed by the stored stress model in a manner that enables independent and automatic closed-loop control and/or open-loop control of the extruder. The extrusion parameters may, for example, be initially provided by external sensors which are not part of the extruder (offline analysis) and, in the course of operation, the extrusion parameters may additionally or alternatively be provided by sensors incorporated in the extruder (inline analysis) or be predicted or prognosticated by corresponding models.

In a preferred refinement, a dispersion of conductive particles in the suspension is used as a product parameter. This means that the suspension is mixed with conductive particles as a conductive additive, the extruder-specific stress model being calculated for a continuous and homogeneous dispersion; i.e., for as uniform a distribution of the conductive particles in the suspension as possible.

In an advantageous embodiment, in order to calculate the stress model, a product characteristic or a quality parameter of the conductive particles, such as, for example, a particle size distribution of the conductive particles, is correlated with a specific energy required to deagglomerate the conductive particles of this product characteristic. In other words, the stress model is based on calculating a specific energy contribution required to deagglomerate (disaggregate) the conductive particles. This enables a particularly reliable and efficient open-loop control and/or closed-loop control of the extruder operation, which is advantageously reflected in the production of the battery.

In order to calculate or determine the stress model, the product characteristic is, for example, characterized by means of a measurement and plotted against the specific energy occurring for the respective extrusion or process parameters. Subsequently, a model curve is fitted to this data. This correlation makes it possible to produce an electrode paste with a specific product characteristic, because the specific energy required for this can be determined from the stored model curve, and thus the extrusion parameters can be controlled in open loop and/or closed loop on the basis of the stress model.

The term “specific energy” is to be taken to mean in particular a specific mechanical energy input. The specific energy, as an extrusion parameter, is a measure of the stress exerted on the product (the electrode paste) by the extrusion process. The specific energy characterizes the extruded electrode paste independently of the size or dimensions of the extruder. Thus, the correlation or association of the specific energy with the product characteristic is an essentially material-specific constant of the electrode paste. This allows a piece of manufacturing equipment or a manufacturing device or the extruder to be readily scaled up, thereby simplifying the production of the battery.

In a suitable embodiment, the product characteristic used is in particular a particle size of the conductive particles. It is desired that the conductive particles constituting a conductive additive be distributed in the suspension as homogeneously or uniformly as possible to ensure improved electrical performance of the battery. Due to the optical properties and the process-related change of the particle size, the particle size is a particularly suitable product characteristic for calculating the stress model. During dispersion, the conductive particles, which are mainly present as agglomerates, are subjected to stress and deagglomerated. This stress, which is mainly caused by shearing, results in changes in the agglomerate or aggregate size of the conductive particles; i.e., in structural changes in the suspension, which can be readily detected using a suitable analysis or measurement method, and thus may be used as a product characteristic or assessment criterion.

The specific energy is dependent on a rotational speed and a rate of (volumetric or mass) flow through the extruder, and can be determined, for example, by measuring the torque at an extruder shaft of the extruder. The specific energy increases with increasing rotational speed and/or decreasing throughput. A problem which occurs in the production of electrode pastes is that the occurring torques are close to an idle power of the extruder, which results in relatively large inaccuracies in the determination of the specific energy. Therefore, a preferred embodiment according to the invention provides for the specific energy to be determined as a function of a shear stress and a degree of filling as well as a density of suspension. This allows the specific energy to be determined reliably and accurately.

The shear stress and the degree of filling as well as the density of suspension are extrusion parameters of the extruder and the extrusion process. The shear stress is in particular a measure of the (shear) load of the extrusion process. The degree of filling is in particular a measure of the fill of the extruder; i.e., a measure of the volume of suspension and conductive particles present in the extruder. The density of suspension is in particular the density of the suspension including the conductive particles dispersed therein.

The shear stress is determined, for example, indirectly using rheological methods. In a suitable embodiment, the shear stress is preferably determined by a shear rate test to measure the shearing stress of the suspension in the extruder. This enables the shear stress to be reliably determined or measured.

In an advantageous embodiment, the shear stress is preferably determined using a rheological model, given a large enough volume of data. This allows the shear stress to be determined in the absence of physical measurement data. In other words, the shear stress is measured at the beginning of the process, in particular by shear rate tests, and in the course of the process, a model curve is determined based on the acquired data and subsequently used to determine the shear stress, preferably without measurement.

The stress caused by shearing and the level of the suspension in the extruder are relevant to the deagglomeration of the conductive particles in the suspension. The volumes that experience high shear load are suitably dimensioned to be relatively large in the extruder.

The shear rate is determined, for example, by the geometrical properties of the extruder; i.e., by the geometrical sizes and dimensions of the extruder elements (conveying elements, kneading elements). In the case of a twin-shaft or twin-screw extruder, the geometrical properties relevant to the determination of the shear rate include, for example, a diameter of the housing bores, a distance between shaft centers, an outer diameter of the conveying elements, an inner diameter of the conveying elements, an outer diameter of the kneading elements, and an inner diameter of the kneading elements. These geometrical properties determine the clearance between the conveying element and the wall and the clearance between the kneading element and the wall; i.e., the regions between the housing wall and the screw flight as well as the intermeshing clearance; i.e, the intermeshing region between the two extruder screws. Due to the geometrical dimensions, particularly high shear rates occur in these regions. The occurring shear rates can be calculated for respective extruder rotational speeds based on the clearance dimensions, for example using a parallel-plate model.

To be able to estimate the shear stresses acting on the particular suspension within the extruder at specific rotational speeds and shear rates, a shear rate test is performed in which so-called “flow curves” are determined by rotational testing of the particular electrode paste. For this purpose, subsequent to dispersion, a sample of the electrode paste is sheared in a rotational viscometer between two surfaces spaced apart by a precisely defined distance. This measurement setup makes it possible to selectively generate different shear rates and to determine the resulting shear stresses at specific shear rates. Specifically, the shear rates in the region of the intermeshing clearance and in the regions between the housing wall and the screw flight are examined in this procedure.

The or each shear rate test provides for each extruded electrode paste a flow curve, which can be plotted in a shear rate-shear stress diagram. Subsequently, a curve shape is fitted to each of the measured (electrode paste-specific) flow curves. The fitting of the curve shape can be accomplished in particular by what is known as a Herschel-Bulkley curve. The fitted curve shape then allows the shear stress to be readily calculated or determined for different shear rates. Advantageously, the curve shape or the function parameters of the fit function are stored for later calculations or interpolation/extrapolation of the shear stress and/or of the specific energy, even for suspensions with unknown rheological properties. Since the fit or function parameters of the fitted Herschel-Bulkley curve have a linear dependence within a wide solids content range, it is possible to determine flow curves as a function of the solids content for suspensions with unknown rheological properties, such as a varying solids content in conjunction with constant relative proportions of solids.

In a possible refinement, the degree of filling is determined via a mean residence time and a volumetric flow rate as extrusion parameters. The residence time is a measure of the stress frequency; i.e., the number of stress events acting on the suspension and the conductive particles or agglomerates in the course of the extrusion process. In this manner, a reliable determination of the degree of filling is achieved.

The degree of filling is therefore also a measure of a residence time behavior of the extrusion process, which has a great influence on the product quality of the electrode paste both during melting and dispersion. When using a co-rotating twin-screw extruder, there is a residence time distribution. While the minimum residence time is important for dispersive mixing, the residence time distribution is important especially for distributive mixing. The residence time is dependent in particular on the process or extrusion parameters of throughput (volumetric flow rate) and (extruder) rotational speed as well as on a screw configuration. Depending on the particular configuration, the screw configuration results in a narrow distribution width (pure conveyor screw) or a wide distribution width (screw with many gear-mixing elements/kneading elements or reverse conveying elements). The screw configuration is a fixed known parameter of the extruder, so that a mean degree of filling can be readily determined by measuring or determining the rotational speed and the volume flow conveyed.

In a preferred embodiment, the extruder used is a twin-shaft or twin-screw extruder. Thus, a particularly suitable extruder is used for the production of batteries. The twin-screw extruder is preferably of a co-rotating, closely intermeshing design having a high mixing and dispersing effect.

In a suitable embodiment, the conductive particle used is carbon black. Thus, a particularly suitable conductive additive is used for the battery, in particular for a lithium-ion battery.

In a preferred application, the method is used for operating a device for producing batteries. The device includes an extruder, in particular a twin-shaft or twin-screw extruder, for extruding electrode pastes, the extruder being coupled to a controller or control unit.

Generally, the controller is adapted by software and/or circuitry to carry out the inventive method described above. Specifically, the controller is thus adapted to monitor the extrusion process, in particular to determine the extrusion parameters, and to control the extrusion process in open loop and/or closed loop on the basis of a stored stress model.

In a preferred embodiment, the controller is formed, at least at its core, by a microcontroller having a processor and a data memory in which the functionality for performing the inventive method is implemented by software in the form of firmware, so that when the firmware is executed in the microcontroller, the method is carried out automatically, possibly in interaction with a user of the device. However, it is also within the scope of the invention that the controller may alternatively be formed by a non-programmable electronic device such as, for example, an application-specific integrated circuit (ASIC) in which the functionality for performing the inventive method is implemented by circuitry.

During the production of a battery, an electrode paste is extruded by the extruder. In this process, the electrode paste is formed from the suspension (electrode active material and binder) and the added conductive particles by means of the extrusion process. In accordance with the invention, the screw configuration of the extruder is initially determined and stored in a memory of the controller. Then, for example, a minimum average value of the particle size of the conductive particles is determined at a maximum coatable solids content, a maximum rotational speed, and a minimum volumetric flow rate as extrusion parameters. Subsequently, this analysis or extrusion parameter is repeatedly determined for suspensions with a reduced solids content at a reduced (extruder) rotational speed and an increased volumetric flow rate, the mean residence time in the extruder being determined in each case. Based on these extrusion parameters, the shear stress and the degree of filling are determined and provided to the stored stress model. The controller controls the extrusion process in open loop and/or closed loop on the basis of the stress model with respect to a desired particle size of the conductive particles in the electrode paste by setting a specific energy required for this.

Thus, the controller can reliably determine a stress model for a reliable and effective operation of the device on the basis of only a few measurements or tests.

The inventive battery is produced using the method described above. The battery is suitable and adapted for a motor vehicle. The battery takes the form of, for example, a lithium-ion battery having a plurality of interconnected battery cells.

An exemplary embodiment of the invention is described below in more detail with reference to the drawings, in which:

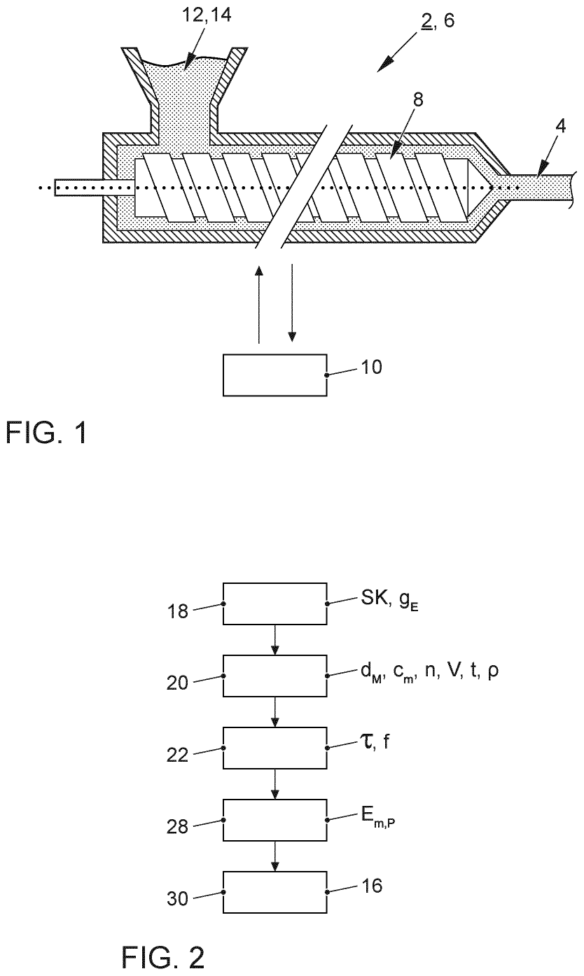

FIG. 1 is a schematic and simplified view of a device for producing batteries including an extruder and a controller;

FIG. 2 is a flow chart of a method for producing batteries;

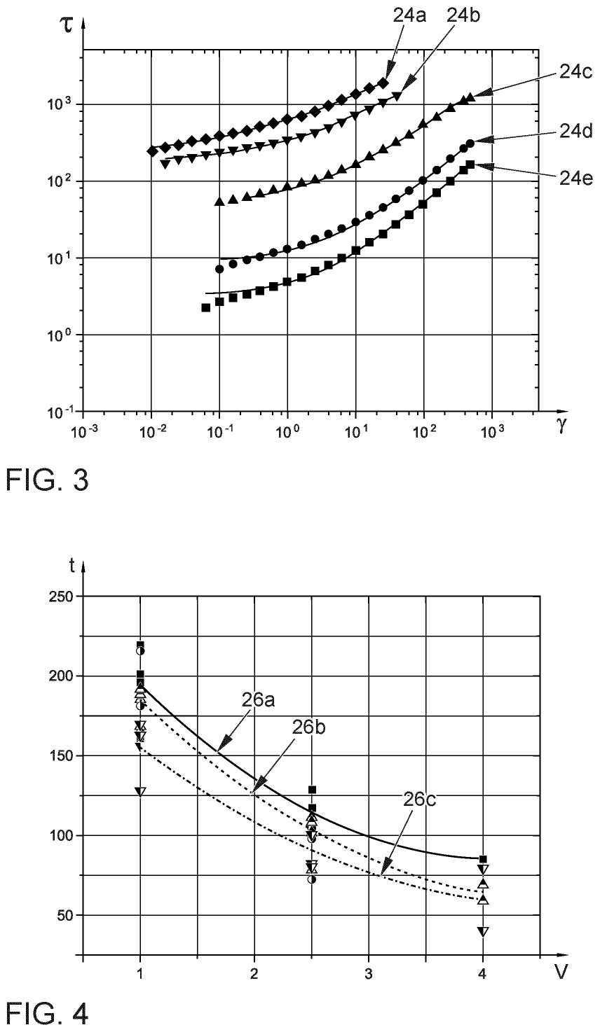

FIG. 3 is a shear stress-shear rate diagram with five flow curves for different solids contents;

FIG. 4 is a volumetric flow rate-residence time diagram for different extruder rotational speeds; and

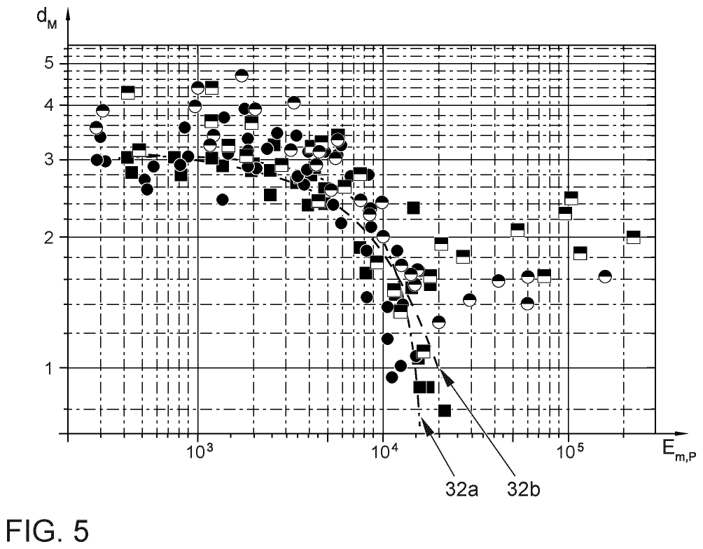

FIG. 5 is a specific energy-particle size diagram for different electrode pastes and volumetric flow rates.

Corresponding parts and quantities are given the same reference numerals throughout the figures.

FIG. 1 shows a device 2 for producing a battery, more particularly, for producing an electrode paste 4 for a battery cell of the battery. Device 2 includes an extruder 6 in the form of a twin-shaft or twin-screw extruder. Extruder 6 has extruder elements 8 (only partially shown) in the form of conveying and/or kneading elements which are driven in co-rotating fashion and configured to closely intermesh with each other. Extruder 6 is coupled to a controller 10.

In order to produce the battery, electrode paste 4 is extruded as an extrudate using extruder 6. In this process, electrode paste 4 is formed from a suspension 12 (electrode active material and binder) and added conductive particles 14 by means of the extrusion process.

Controller 10 is suitable and adapted to monitor the extrusion process and extruder 6, in particular to determine extrusion parameters, and to control the extrusion process in open loop and/or closed loop on the basis of a stored stress model 16. In particular, controller 10 is suitable and adapted to control extruder 6 in open loop and/or closed loop with respect to a product characteristic of conductive particles 14 in electrode paste 4. Thus, extruder 6 is controlled in open loop and/or closed loop in such a way that the desired product characteristic of conductive particles 14 is achieved in the extruded electrode paste 4. In this process, the desired product characteristic is achieved in particular by setting a specific energy of the extruder that is required in each case.

To this end, the product characteristic is correlated in stress model 16 with the specific energy required to deagglomerate the conductive particles of this product characteristic.

An inventive method for producing a battery is described hereinafter with reference to FIGS. 2 through 5. The method is described here by way of example for conductive particles 14 in the form of carbon black, the desired product characteristic being in particular a particle size d_{M} of the conductive particles.

In a first method step 18, a screw configuration SK as well as the geometrical properties g_{E} of extruder 6; i.e., the geometrical sizes and dimensions of extruder elements 8, in particular the clearance between extruder elements 8 and the inner wall of extruder 8 as well as the intermeshing clearance between intermeshing extruder elements 8, are determined and stored in a memory of controller 10.

In a method step 20, a minimum average value of the particle size d_{M} of the conductive particles is determined at a maximum coatable solids content cₘ, a maximum (extruder) rotational speed n, and a minimum volumetric flow rate V as extrusion parameters. Subsequently, product characteristic d_{M} is determined for reduced solids contents cₘ, a reduced rotational speed n, and an increased volumetric flow rate V. Also determined in each case are the mean residence time t and the density of suspension ρ in extruder 6.

In a method step 22, a shear stress τ and a degree of filling f are determined based on these extrusion parameters or analysis data.

The shear stress τ acting on the particular suspension 12 within extruder 6 at specific rotational speeds n and shear rates γ are determined by a shear rate test in which so-called “flow curves” are determined by rotational testing of the particular electrode paste 4.

The or each shear rate test provides for each extruded electrode paste 4 a flow curve, which can be plotted by way of example in a shear rate-shear stress diagram shown in FIG. 3. In FIG. 3, shear rate γ is represented along the abscissa axis (X-axis) and shear stress τ along the ordinate axis (Y-axis) in a double-logarithmic fashion, shear rate γ being plotted in units of s⁻¹ (second⁻¹) and shear stress τ in units of Pa (pascal).

FIG. 3 shows, by way of example, five flow curves 24a, 24b, 24c, 24d and 24e. Flow curves 24a, 24b, 24c, 24d and 24e were measured for a suspension 12 at the same speed n, the same screw configuration SK, and the same volumetric flow rate V, and differ only in their respective solids content cₘ, flow curve 24a having the highest solids content cₘ and flow curve 24e having the lowest solids content cₘ. A curve shape is fitted to each of the measured (electrode paste-specific) flow curves 24a, 24b, 24c, 24d and 24e. The curve shape is in particular what is known as a Herschel-Bulkley curve.

FIG. 4 shows a volumetric flow rate-residence time diagram in which the volumetric flow rate V is plotted along the abscissa axis and the mean residence time t is plotted along the ordinate axis. The volumetric flow rate V is plotted in the unit of l/h (liters per hour) and the mean residence time tin the unit of s (seconds). The diagram of FIG. 4 shows three parabolic curve shapes 26a, 26b and 26c for different rotational speeds n.

Curves 24a, 24b, 24c, 24d, 26a, 26b and 26c are stored in a memory of controller 10.

The degree of filling f of extruder 6 is calculated based on the free extruder volume V_{free}, which can be determined from the geometrical properties g_{E}, and on a corresponding mean residence time t at a given volumetric flow rate V using the following formula:

$$f = \frac{V}{{V}_{f r e e}} \times t .$$

Based on the extrusion parameters determined in method step 20 and the stored curves 24a, 24b, 24c, 24d, 26a, 26b and 26c, the shear stress τ and the degree of filling f can thus be easily determined for the particular prevailing extrusion parameters.

In a method step 28, a specific energy E_{m,P} is calculated based on the degree of filling f of extruder 6 and based on the shear stress τ within extruder 6 at a prevailing shear rate γ as well as based on the density of the particular electrode paste p. The specific energy E_{m,P} is derived as follows:

$${E}_{m , P} = \frac{1}{f} \times τ / ρ .$$

In a method step 30, stress model 16 is calculated. To this end, the specific energy E_{m,P} is correlated with the particle size d_{M} of conductive particles 14. Such a correlation is illustrated, for example, in FIG. 5 by means of a specific energy-particle size diagram. The calculated specific energy E_{m,P} is plotted in units of J/kg (joule per kilogram) along the abscissa axis and the particle size d_{M} in units of μm (micrometer) along the ordinate axis in a double-logarithmic fashion.

In FIG. 5, the dependence of the resulting particle size d_{M} in electrode paste 4 is illustrated for two different suspensions 14 and two different respective volumetric flow rates V. The fully filled squares represent a suspension 12 with a cathode active material for a volumetric flow rate V of 1 l/h. The fully filled circles represent a suspension 12 with a cathode active material for a volumetric flow rate V of 2.5 l/h. The half-filled squares represent a suspension 12 with an anode active material for a volumetric flow rate V of 1 l/h. The fully filled circles represent a suspension 12 with an anode active material for a volumetric flow rate V of 2.5 l/h.

In FIG. 5, the behaviors of the cathode suspensions are each fitted with a respective model curve 32a, 32b, of which model curve 32a describes the behavior for the high volumetric flow rate V.

In method step 30, model curves 32a, 32b are determined and stored in a memory of controller 10. Controller 10 controls the extrusion process in open loop and/or closed loop on the basis of stress model 16 or model curves 32a, 32b with respect to a desired particle size d_{M} of conductive particles 14 in electrode paste 4 by setting a specific energy E_{m,P} required for this.

The claimed invention is not limited to the exemplary embodiment described above. Rather, other variants of the invention may also be derived therefrom by those skilled in the art within the scope of the disclosed claims without departing from the subject matter of the claimed invention. Furthermore and in particular, all individual features described in connection with the exemplary embodiment may also be combined in other ways within the scope of the disclosed claims without departing from the subject matter of the claimed invention.

### LIST OF REFERENCE CHARACTERS

2 device
4 electrode paste
6 extruder
8 extruder elements
10 controller
12 suspension
14 conductive particles
16 stress model
18, 20, 22 method step
24a, 24b, 24c, 24d, 24e flow curve
26a, 26b, 26c curve shape
28, 30 method step
32a, 32b model curve
d_{M} product characteristic
SK screw configuration
g_{E} geometrical property
cₘ solids content
n rotational speed
V volumetric flow rate
t residence time
ρ density of suspension
τ shear stress
f degree of filling
γ shear rate
E_{m,P} specific energy

1. A method for producing batteries, comprising:
extruding a suspension with a variable product parameter as an electrode paste in an extrusion process by means of an extruder,
determining a number of extrusion parameters of the extrusion process,
calculating an extruder-specific stress model on the basis of the extrusion parameters, and
controlling the extrusion process in an open loop and/or a closed loop on the basis of the stress model.

2. The method as recited in claim 1,
wherein the product parameter used is a dispersion of conductive particles in the suspension, and
wherein the stress model is calculated for a continuous dispersion of the conductive particles in the suspension.

3. The method as recited in claim 2, wherein, in order to calculate the stress mode, a product characteristic (d_{M}) of the conductive particles is correlated with a specific energy required to deagglomerate the conductive particles with the product characteristic.

4. The method as recited in claim 3, wherein the product characteristic used is a particle size of the conductive particles.

5. The method as recited in claim 3, wherein the specific energy is determined as a function of a shear stress and a degree of filling and of a density of suspension as extrusion parameters.

6. The method as recited in claim 5, wherein the shear stress is determined by a shear rate test, on the basis of a measured flow curve, and on the basis of geometrical properties of the extruder as extrusion parameters.

7. The method as recited in claim 5, wherein the degree of filling is determined via a mean residence time and a volumetric flow rate as extrusion parameters.

8. The method as recited in claim 1, wherein the extruder used is a twin-shaft extruder.

9. A device for producing batteries, comprising an extruder and a controller for carrying out the method according to claim 1.

10. A battery for a motor vehicle, produced using a method according to claim 1.
